(19) United States
(12) Patent Application Publication
(10) Pub. No.: US 2009/0310817 A1
(43) Pub. Date: Dec. 17, 2009

(54) WATERMARKING METHOD, WATERMARK CHECKING METHOD, WATERMARKING DEVICE, AND WATERMARK CHECKING DEVICE

(75) Inventors: Ran K. Park, Suwon-Si (KR); Kil Pyo Han, Yongin-Si (KR); Jin Yi Kim, Seocho-gu (KR)

Correspondence Address: BLANK ROME LLP, WATERGATE, 600 NEW HAMPSHIRE AVENUE, N.W., WASHINGTON, DC, 20037, US

(73) Assignee: POSDATA CO., LTD.

(21) Appl. No.: 12/306,852

(22) PCT Filed: Jun. 29, 2007
(86) PCT No.: PCT/KR07/03184

§ 371 Date: Dec. 29, 2008

(30) Foreign Application Priority Data
Jun. 30, 2006 (KR) 10-2006-0060934

(51) Int. Cl. G06K 9/00

(52) U.S. Cl. 382/100

(57) ABSTRACT

A watermarking method is provided. The method includes: the steps of creating an entire watermark for an image frame by using a secret key; dividing an image frame of the digital image file into divided frames by at least one row and at least one column; applying a predetermined watermark creating algorithm to pixel data of each divided frame to generate a unit watermark; and applying the unit watermarks with the digital image file. The step of creating the unit watermark uses a public key or applies a keyless algorithm. Another watermarking method includes the steps of dividing the image frame into a plurality of divided frames, each divided frame partially overlapping neighboring divided frames; applying a predetermined watermark creating algorithm to pixel data of each divided frame to generate a unit watermark; and applying the unit watermarks with the digital image file. With the watermarking method and the checking method, a forged or faked area of the image frame can be detected without increasing the amount of computation.

### TECHNICAL FIELD

The present invention relates to a device and method for preventing forgery and faking of image data using watermarks, and more particularly, to a device and method for preventing forgery and faking of image data which are capable of detecting a forged or faked position.

### BACKGROUND ART

Advanced Internet and multimedia techniques have led to the development of services and systems that provide digital image data. A digital moving image can be easily forged or faked by using a digital moving image editing tool.

That is, recent developments in digital image data processing have led to various convenient applications, but also to illegal data forgery and faking.

In particular, forgery and faking of images acquired by a secure system comprising a digital video recorder (DVR) may degrade the reliability of the secure system.

A watermarking technique has been developed to prevent such forgery and faking of digital image data. The watermarking technique involves embedding a specific mark into multimedia data so that user-defined information is not visually recognized, and checking if an original image is forged or faked by using a separate mark extractor.

In a conventional watermarking method, a predetermined watermarking algorithm is applied to all pixel data of an image frame that are image data at one instant to create a watermark, and a receiving side receives the watermark with the image frame, creates a watermark, and compares the created watermark with the received watermark.

With the conventional method, it is impossible to detect a specific forged or faked area of an image since a watermark is applied to an entire original image frame.

### DISCLOSURE

### Technical Problem

The present invention is directed to a watermarking method and a watermark checking method which are capable of detecting a forged or faked area of an image frame.

The present invention is also directed to a watermarking method and a watermark checking method which are capable of minimizing the amount of computation applied with watermarking and performing efficient operation.

The present invention is also directed to a watermarking method and a watermark checking method which are capable of defending against a collage attack.

### Technical Solution

One aspect of the present invention provides a watermarking method for embedding watermarks into a digital image file, the method comprising the steps of: (a) generating an entire watermark for an image frame of the digital image file using a secret key; (b) dividing the image frame into divided frames by at least one horizontal line and at least one vertical line; (c) performing a predetermined watermark creating algorithm on pixel data of each divided frame and generating a unit watermark; and (d) applying the entire watermark and the unit watermarks to the digital image file.

Another aspect of the present invention provides a method for checking watermarks embedded in a digital image file, the method comprising the steps of: (a) calculating an entire watermark for an image frame of the digital image file according to a predetermined algorithm using a secret key, to determine whether the image frame is forged or faked; (b) extracting a unit watermark for each divided frame from the image frame; (c) dividing the image frame into a number of divided frames, and calculating a unit watermark for each divided frame according to a predetermined algorithm; and (d) comparing the extracted unit watermark with the calculated unit watermark to determine whether each divided frame is forged or faked.

Still another aspect of the present invention provides a watermarking apparatus for embedding watermarks into a digital image file, the apparatus comprising: an entire watermark generating unit for generating an entire watermark for an image frame of the digital image file; a frame dividing unit for dividing an image frame to be watermarked into a number of divided frames; a unit watermark generating unit for generating a unit watermark for each divided frame by applying a public key algorithm or a keyless algorithm; and a file applying unit for applying the entire watermark and unit watermark information to the digital image file.

Yet another aspect of the present invention provides an apparatus for checking watermarks embedded in a digital image file, the apparatus comprising: an additional-information extracting unit for extracting information on a watermarking scheme from a watermarked image file; an entire-watermark checking unit for extracting and checking an entire watermark for the image frame from the image file using a secret key; a frame dividing unit for dividing the image frame of the watermarked image file into a number of divided frames according to the additional information; a unit-watermark extracting unit for extracting the unit watermark for each unit frame from the additional information; a unit-watermark calculating unit for calculating the unit watermark by applying a predetermined watermarking algorithm to each divided frame; and a comparing unit for comparing the extracted unit watermark for each divided frame to the calculated unit watermark to determine whether the image file is forged or faked.

### ADVANTAGEOUS EFFECTS

With the watermarking method and the checking method of the present invention, a forged or faked area of the image frame can be detected without increasing the amount of computation.

In addition, a collage attack can be efficiently defended against.

### DESCRIPTION OF DRAWINGS

FIG. 1 is a block diagram illustrating a structure of a watermarking device according to an exemplary embodiment of the present invention;

FIGS. 2a to 2d are conceptual diagrams illustrating a watermarking method according to an exemplary embodiment of the present invention;

FIG. 3 is a block diagram illustrating a structure of a watermark checking device according to an exemplary embodiment of the present invention;

FIG. 4 is a conceptual diagram illustrating a watermarking method according to another exemplary embodiment of the present invention;

FIGS. 5a to 5b are conceptual diagrams illustrating a watermarking method according to still another exemplary embodiment of the present invention;

FIG. 6 is a block diagram illustrating a digital image file consisting of one image frame according to an exemplary embodiment of the present invention; and

FIG. 7 is a conceptual diagram illustrating a watermark key distribution method according to an exemplary embodiment of the present invention.

### DESCRIPTION OF MAJOR REFERENCE NUMERALS IN THE ABOVE FIGURES

101: Entire watermark generating unit
102: Frame dividing unit
103: Unit watermark generating unit
104: File applying unit
105: Watermark key generating unit
106: Key encrypting unit
201: Unit-watermark extracting unit
202: Additional-information extracting unit
203: Frame dividing unit
204: unit-watermark calculating unit
205: Comparing unit
206: Key decryption unit

### MODE FOR INVENTION

Hereinafter, exemplary embodiments of the present invention will be described in detail. However, the present invention is not limited to the exemplary embodiments disclosed below, but can be implemented in various forms. The following exemplary embodiments are described in order to fully enable those of ordinary skill in the art to embody and practice the invention.

### First Exemplary Embodiment

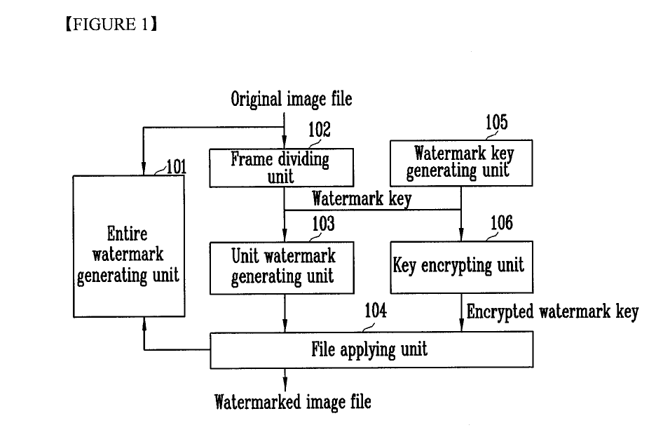

FIG. 1 shows a watermarking device according to a first exemplary embodiment of the present invention.

The watermarking device includes a frame dividing unit 102 for dividing an image frame to be watermarked into divided frames of a single size; a unit watermark generating unit 103 for generating a watermark for each divided frame; an entire watermark generating unit 101 for generating a watermark for the image frame; and a file applying unit 104 for applying the unit watermarks and watermark checking information with an image frame file.

Preferably, for security and convenience, the entire watermark generating unit 101 uses a secret key as a watermarking encryption key (referred to as a “watermark key”), and a watermark checking side uses a public key corresponding to the encryption key of the unit watermark generating unit 103. However, when the entire watermark generating unit 101 is not required or when a high level of security is required, the unit watermark generating unit 130 may also use the secret key.

Here, the secret key refers to an encryption key owned only by an authority that creates a watermark and an authority that checks the watermark. The public key refers to a common encryption key owned by all authorities that check the watermark.

Since the entire watermark generating unit 101 is well known, a detailed description of the entire watermark generating unit 101 and its encryption key will be omitted.

The watermarking device may further include a watermark key generating unit 105 for generating a watermark key used by the unit watermark generating unit 103. The watermark key generating unit 105 may generate different watermark keys based on a seed value dependent on an image file or image frame. The watermarking device may further include a key encrypting unit 106 for encrypting the watermark key generated by the watermark key generating unit 105 so that the watermark key is applied with the file. The key encrypting unit 160 may encrypt the watermark key by using the secret key of the entire watermark generating unit 101.

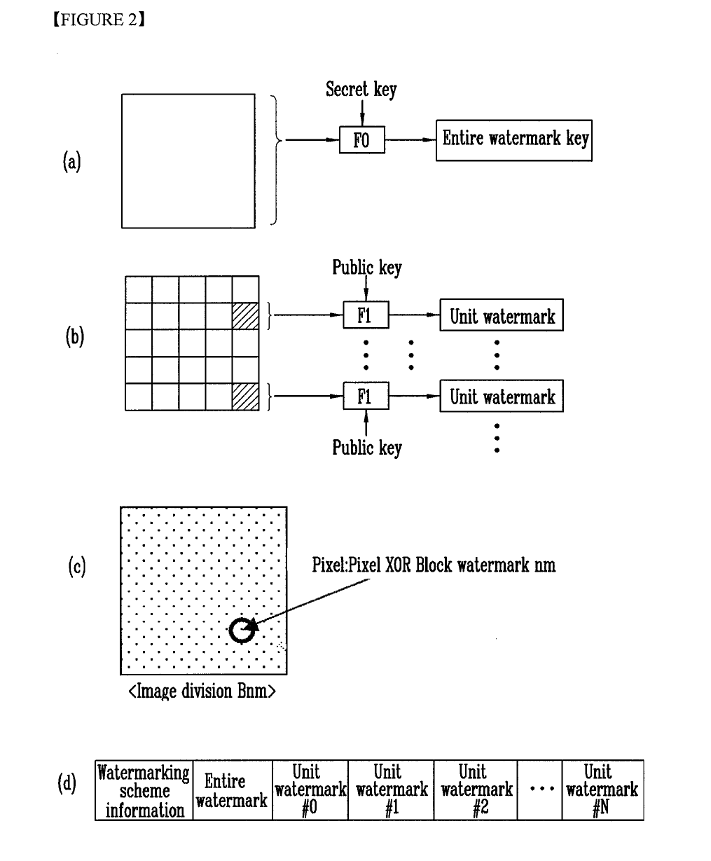

FIGS. 2a to 2d show a method for watermarking divided frames of a predetermined size according to the present exemplary embodiment.

As shown in FIG. 2a, first, an entire watermark for an image frame, which is image data according to an entire area at an instant, is generated by using the secret key. As shown in FIG. 2b, the image frame is divided into divided frames of the same size, and a unit watermark for each divided frame is generated by using the public key. As shown in FIG. 2c, each unit watermark is then written to the corresponding divided frame. Writing the unit watermarks to the divided frames will be described in detail later.

An additional information block is formed which includes information on a watermarking scheme applied to the image file, the entire watermark, and a plurality of the unit watermarks, as shown in FIG. 2d. The additional information block is applied with the image file.

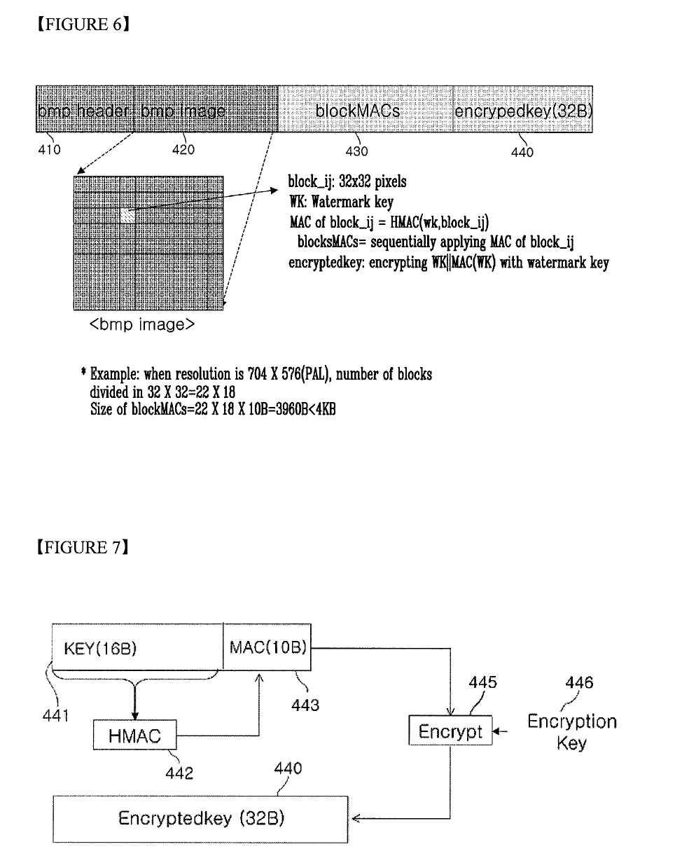

FIG. 6 illustrates an image file including one image frame. The image file includes a header 410, an image frame 420, a watermark block 430, and a watermark key block 440. The header 410 includes basic information on the image file.

In the present exemplary embodiment, a dual watermarking structure of the entire watermark and the unit watermark is used because using only the entire watermark makes it impossible to check a forged or faked portion, and using only the unit watermark makes it impossible to cope with a collage attack (an attack in which an attacker creates new content by combining authenticated blocks).

In the present exemplary embodiment, use of the divided frame of a single fixed size makes frame dividing relatively simple. That is, the frame dividing unit 102 divides the image frame into divided frames each having a prescribed number of horizontal and vertical pixels, i.e., divides the image frame at uniform intervals in horizontal and vertical directions to divide the image, as shown in FIG. 2b. Assuming that the horizontal and vertical dividing numbers of the image are HorCount and VerCount, respectively, the number of divided images is width/HorCount*height/VerCount.

The unit watermark generating unit 103 generates a unit watermark for each divided frame by applying all pixel data of each divided frame to a predetermined unit watermark creating algorithm.

For example, the watermark creation shown in FIGS. 2a to 2d based on a relatively simple algorithm for creating a watermark through an XOR operation will be described in detail.

First, the watermark for each divided image is generated. Assuming that the horizontal division number of the image is HorCount and the vertical division number is VerCount, watermarks for all (n,m)-th divided images Bnm are obtained, and watermark information for the divided images is formed by combining the watermarks, where m=0, 1, . . . , HorCount −1, and n=0, 1, . . . , VerCount −1. A function F1 for creating the watermark for each dividedframe may differ from an authentication function (F0) for the entire image frame. For example, when the authentication function (F0) for the entire image frame is an application of a cryptological function, the authentication function (F1) for the dividedframes is obtained by a keyless non-cryptographic CRC checksum or XOR sum. In this case, the watermark key generating unit and the key encrypting unit will not be required.

However, even when the authentication function (F0) for the entire image frame is an application of the cryptological function, the function F1 for creating the watermarks for dividedframes may be an authentication function based on cryptological message authentication code. For example, the function F1 for creating the watermarks for dividedframes may be a cryptological hash function or an HMAC function based on a secret key encryption algorithm.

However, when the entire watermark for image data corresponding to an entire area is not used, the authentication function based on the cryptological message authentication code is used as the function (F1) for creating the watermarks for dividedframes. For example, the function (F1) for creating the watermarks for dividedframes may be a cryptological hash function of a HMAC function based on a secret key encryption algorithm.

The file applying unit 104 conceals the watermark in the file by appending the watermark as additional information, such as a header or footer, to the original image file, or by modifying the original image file without affecting image quality according to the generated watermark information.

The former technique is easily implemented and does not cause a loss of original file information, but provides low-level security because of simple watermark identification. On the other hand, the latter technique provides high-level security because of the difficulty in extracting watermark information from an image file, but is not easily implemented and causes loss of original file information.

The latter may be performed by a typical watermark concealing technique, such as converting a dividedframe into a two-dimensional frequency signal by using FFT and writing a watermark to a high frequency component that hardly affect an image quality.

An alternative method stores the watermark of each divided image in a specific pixel of each divided image as shown in FIG. 2c. For example, the watermark information for the divided image is stored in a reference pixel of the divided image. The reference pixel is determined and then a reversible operation is performed on a pixel value of the reference pixel and the watermark value for the divided image. For example, the reversible operation may be an XOR operation. In the case of a black-and-white image, a pixel consists of approximately 8 bits. In the case of a color image, a pixel consists of 24 bits or more. This size requires a small storage space but may degrade the quality of an image.

In the present invention, since the watermark is generated for all the divided frames, a total size of the watermark information is large. Since concealing such a large amount of watermark information in the image file greatly degrades image quality, the former technique is preferred in actuality, which will now be described.

When the watermark generating unit generates the unit watermark for each divided frame, the file applying unit combines the unit watermarks in order of the divided frames in order to generate the additional information. The generated additional information is translated into a header or footer of the image file and appended to the image file, or translated into a header or footer of each image frame and appended to each image frame. Preferably, the additional information includes information on divided frame implementation (e.g., the size of the divided frame).

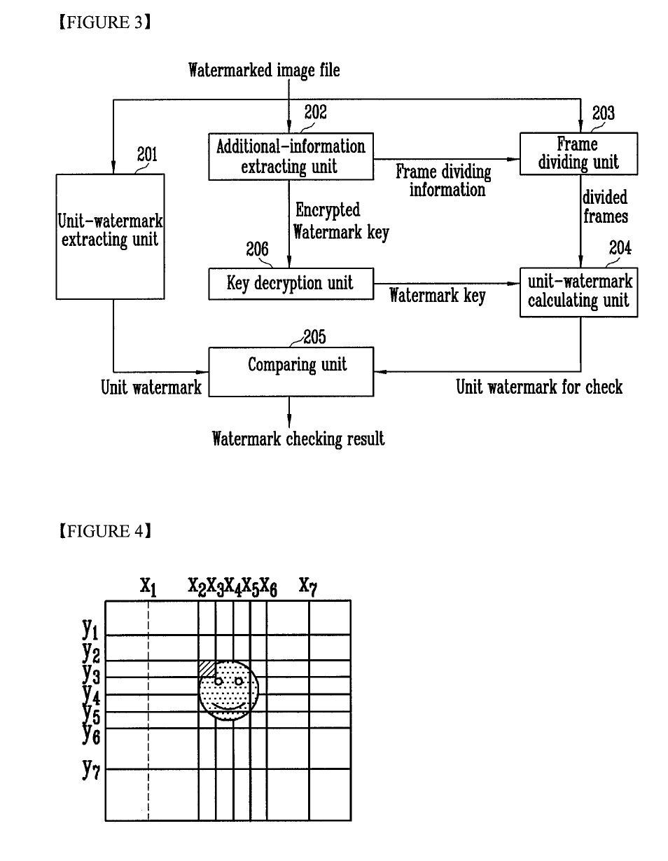

FIG. 3 shows a structure of the watermark checking device according to the present exemplary embodiment. The watermark checking device includes an additional-information extracting unit 202 for extracting information on a watermarking scheme from a watermarked image file; an entire-watermark checking unit (not shown) for extracting and checking the entire watermark for the image frame from the image file using a secret key; a frame dividing unit 203 for dividing the image frame of the watermarked image file into a plurality of divided frames according to the additional information; a unit-watermark extracting unit 201 for extracting the unit watermark for each unit frame from the additional information; a unit-watermark calculating unit 204 for calculating the unit watermark by applying a predetermined watermarking algorithm to each divided frame with or without a public key; and a comparing unit 205 for comparing the extracted unit watermark for each divided frame to the calculated unit watermark to determine whether the image file is forged or faked.

A method for authenticating a watermark of a file that has watermark information appended thereto using the divided frames having a fixed size in the watermark checking device of FIG. 3 will now be described.

First, the entire watermark for the entire image frame is checked. That is, a determination is made as to whether the watermark, of the image frame separated from the image file, obtained by using the secret key, is the same as the entire watermark written as the additional information to the image file. This determination is made by the entire-watermark checking unit. Since checking the entire watermark is performed by using a conventional checking technique, a description of the watermark check is not illustrated separately.

The unit watermark for each divided frame is then checked. An original pixel value is restored from the divided image to generate the watermark. A determination is made as to whether the generated watermark is the same as a watermark for each divided image. This process will now be described.

The additional-information extracting unit 202 extracts the additional information from the watermark appended to the received image file. The unit-watermark extracting unit 201 extracts the watermark information from the received image file. That is, the unit-watermark extracting unit 201 collects dividing information of each image frame from the additional information and obtains the unit watermark for each divided frame.

The frame dividing unit 203 divides the image frame of one screen into divided frames by using the dividing information contained in the additional information.

The unit-watermark calculating unit 204 applies pixel data of each divided frame to a predetermined watermark decoding algorithm to calculate the unit watermark for the divided frame. The comparing unit 205 compares the calculated unit watermark with the unit watermark obtained from each divided frame by the watermark extracting unit. The similarity between the two unit watermarks indicates that the image of the divided frame is not forged or faked, and the difference between the two watermarks indicates that the divided frame is not reliable. This unit watermark checking process is performed on all the divided frames and the result is output.

As described above, in the present exemplary embodiment, watermark authentication is performed by using the secret key for the entire image frame and, simultaneously, the watermark for each divided frame is generated to detect illegal forgery and faking by a collage attack. In this case, the authentication function (F) for the entire image frame needs to be a cryptological authentication function with the secret key while the function BF for the divided frame may be a non-cryptographic checksum function, such as cyclic redundancy check (CRC), XOR, or the like, since the secret key is not required.

A method for distributing the watermark key for generating the unit watermark in the present exemplary embodiment will be described. The watermark key is generated based on a method for generating a key for use of the cryptological authentication function, and can be stored by encrypting the key as the additional information for the image file.

When the use of a public key-based structure or a public key pair is allowed, the watermark key can be stored by encrypting the key with the public key. In this case, generating and checking the watermark requires a private key. Alternatively, the watermark key can be stored by encrypting it with a secret key generated by user input or a unique key management method. In this case, generating and checking the watermark requires the secret key generated by the user input or the unique key management method.

FIG. 7 shows a key distribution method according to the present exemplary embodiment.

A MAC value 443 generated by a predetermined signature algorithm 442 is appended to a key 441 for generating the entire watermark and/or the unit watermark, and then the key 441 is encrypted by a predetermined encryption algorithm 445 to generate encrypted key data 440. In this case, an encryption key 446 may be used for the encryption algorithm, and a side receiving the digital image file has a decryption key corresponding to the encryption key 446. In this manner, the encrypted key data is appended as the watermark key block 440 of FIG. 6 to the image file and distributed.

A process of dividing the image frame into frames of a fixed size and generating the watermark by using a cryptological authentication function, such as a Hashed Message Authentication Code (HMAC) function, as the function BF for the divided image, and by using the secret key may be implemented by a programming language, as follows:

int SCWatermark(width, height, bitDepth, bwidth, bheight, HCount, VCount, buf, passwd, output, outMACLength, outMessage)

| | |
|---|---|
| unsigned int width; | //horizontal width of bitmap image |
| unsigned int height; | // veritcal height of bitmap image |

| | |
|---|---|
| unsigned int bitDepth; | // bits for pixel representation, usually 24bits |
| unsigned | |

| | |
|---|---|
| int bwidth; | // block width, ususally 32bits for max resolution |

| | |
|---|---|
| unsigned int bheight; | // block height, ususally 32bits for max resolution |
| unsigned int HCount; | // maximum horizontal division count of width, so |

width = bwidth * HCount

| | |
|---|---|
| unsigned int VCount; | // maximum vertical division count of width, so height = |
| bheight * VCount | |

| | |
|---|---|
| unsigned char *buf; | // bitmap image value, size = width*height*bitDepth/8 |
| Bytes | |

| | |
|---|---|
| unsigned char *passwd; | // password for watermark key derivation |

| | |
|---|---|
| unsigned char *output; | // output = outMACs∥encryptedKey |

unsigned int outMACLength; // the length of outMACs,
HCount*VCount*10bytes

| | |
|---|---|
| unsigned char *outMessage; | // Log or Error code |

| | |
|---|---|
| { | unsigned int k, m, n, s, t; |

| | |
|---|---|
| unsigned char | blockbuf[bwidth*bheight*bitDepth/8]; |

unsigned int pixelsize;
unsigned int blockindex=0, bufindex=0;

| | |
|---|---|
| pixelsize = bitDepth/8; | // number of bytes for pixel representation |
| outMACLength = 0; | |

if (pixelsize < 3) printf(“\n Input Error in bitDepth=%3d pixelsize=%3d ”, bitDepth,
pixelsize);

| | |
|---|---|
| else printf(“\n bitDepth=%3d pixelsize=%3d ”, bitDepth, pixelsize); | // make |
| watermark key (WK) using random number | |
| // make watermark key encryption key (WKEK) using passwd | |
| for (n=0; n< VCount; n++){ | |

| | |
|---|---|
| for (m=0; m< HCount; m++){ | // begin to make (n, m)-th block for (t=0; |

| | | |
|---|---|---|
| t<bheight; t++){ | printf(“\nt=%3d ”, t); | for (s=0; s<bwidth; |

| | |
|---|---|
| s++){ | blockindex = s + t* bwidth; |

blockindex = pixelsize*blockindex;
bufindex = s+m*bwidth+(t + n*bheight)*width;
bufindex = pixelsize*bufindex;
printf(“\n”);
for (k=0; k<pixelsize; k++){
blockbuf[blockindex]= buf[bufindex];

| | | | |
|---|---|---|---|
| printf(“index=%3d(bl) | %3d(bf) | ”, | blockindex, |

| | |
|---|---|
| bufindex); | blockindex++; |

| | | | |
|---|---|---|---|
| bufindex++; | } | } | }// end to make |
| (n,m)-th block | | | |

// make HMAC for blockbuf using watermark key (WK)
// make output = output ∥ MAC

| | | | |
|---|---|---|---|
| outMACLength += 10; | } | } | // check if |

outMACLength == HCount * VCount, else error
// make encryptedKey such as encryptedkey = Encryption of WK∥MAC(WK) using
key(WKEK)
// make output = output ∥ encryptedKey
// make outMessage with LOG or ERROR}

### Second Exemplary Embodiment

In the second exemplary embodiment, an image frame to be watermarked is divided into divided frames of a size varying with the image frame. A step of dividing the image frame into the divided frames differs from the first exemplary embodiment, while other steps are substantially the same as in the first exemplary embodiment although somewhat more complex. Accordingly, the step of dividing the image frame into the divided frames will now be described.

In the present exemplary embodiment, a primary object or a moving object is divided at smaller intervals and a background or a foreground is divided at greater intervals.

This division scheme is useful to detect a forged or faked area of the image more specifically. Through a foreground modeling and motion recognition scheme, a moving object and a background are separated from the image, and the moving object or a primary portion to be monitored are divided at smaller intervals and the background is divided at greater intervals. The dividing interval varies with need and objects.

Specifically, to recognize a desired object, the background and the object are separated through a background modeling process of extracting the background, which rarely moves compared to the object, from an input moving image. The object can be recognized by separating the object and the background by obtaining a differential image between a current frame and a next frame. To recognize the object, several background modeling schemes such as a Kumar method, called queue-based background modeling, have been proposed as a pre-processing process.

A background subtraction step for extracting a moving object is a key process in a real-time surveillance system. There is a background modeling and maintaining method for effectively subtracting the background, such as adaptive Gaussian mixture background modeling.

The reason for using the divided frames in the present exemplary embodiment is that forgery/fake prevention importance differs from frame portion to frame portion.

For example, while a simple background has a lower forgery/fake prevention importance since the background does not affect an original image frame message when forged or faked, the object of the image frame, such as a person, has higher forgery/fake prevention importance since the object greatly affects the original image frame message when forged or faked.

The watermarking device of the present exemplary embodiment has a basic structure as shown in FIG. 1. The frame dividing unit 102 of the present exemplary embodiment analyzes an image frame to be watermarked to determine a suitable dividing area. As an image frame analyzing algorithm, a conventional technique, such as an image object extracting technique, may be used. In this case, an object area is divided into divided frames having a smaller size and a non-object area is divided into divided frames having a greater size.

Subsequent processes are the same as in the first exemplary embodiment. However, in the present exemplary embodiment, information for divided frame implementation is somewhat complicated. FIG. 4 shows a characteristic of a method for authenticating watermarks of a file having watermark information appended thereto by using divided frames of variable size.

In the present exemplary embodiment, as additional information for watermarking, information on an individual dividing pattern for each image frame is required. The dividing pattern information may include horizontal coordinate values x1, x2, . . . , x7 and vertical coordinate values y1, y2, . . . , y7 indicating horizontal/vertical divisions of the frame as shown in FIG. 4. Alternatively, the dividing pattern information may include an individual coordinate value of each divided frame (e.g., a top left coordinate value and a bottom right coordinate value of each rectangular divided frame).

Even in the present exemplary embodiment, the watermark for all image frames may be additionally generated to defend against a collage attack. For example, for an authentication function (F) for precisely authenticating the image frame, a watermark for a secret key is obtained. In this case, the authentication function (F) needs to be a function based on a cryptological message authentication code. For example, the function (F) may be a cryptological hash function or an HMAC function based on a secret key encryption algorithm.

Since the steps of the present exemplary embodiment are substantially the same as in the first exemplary embodiment, a description thereof will be omitted.

### Third Exemplary Embodiment

In a watermarking method according to the present exemplary embodiment, divided frames overlap each other. The divided frames may have a fixed size or variable size but partially overlap neighboring divided frames. Aspects of the present exemplary embodiment that are the same as in the first exemplary embodiment will not be described again. In the present exemplary embodiment, overlapping the divided frames leads to the following advantages:

First, in the case where an attacker is allowed to easily obtain dividing information of the divided frames, some divided frames of an image frame may be combined with other image frames to forge an image. This forgery cannot be easily detected by the invention according to the first and second exemplary embodiments. Prevention of such forgery requires watermarking the entire image frame, which unnecessarily degrades operational efficiency.

On the other hand, overlapping the divided frames as in the present exemplary embodiment makes it possible to easily detect forgery since a forged divided frame changes neighboring divided frames.

Second, since the image frame area includes an area included in only one divided frame, an overlapping area included in two divided frames, and an overlapping area included in four divided frames, the image frame can be divided into a smaller number of divided frames than in a non-overlapping scheme, and the number of the divided areas of the image frame may increase.

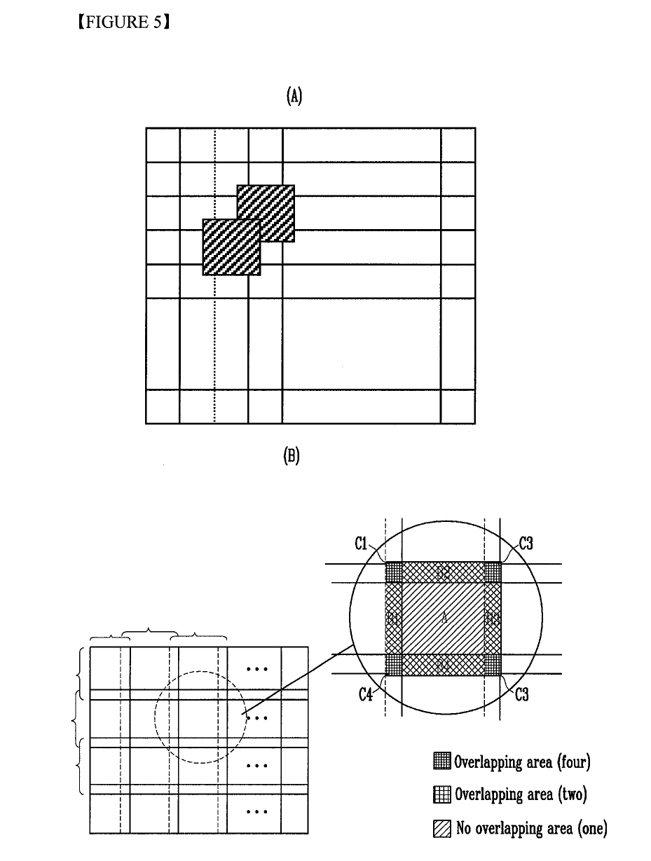

Each frame divided by a fixed or variable division scheme partially overlaps neighboring divided frames because of its expanded area, having a predetermined length, as shown in FIG. 5a. That is, as shown in FIG. 5b, when an area A is forged or faked, a unit watermark for only one divided frame including the area A suffers discrepancy. However, when an area B1 is forged or faked, unit watermarks for two divided frames including the area B1 suffer discrepancy, and when an area C1 is forged or faked, unit watermarks for four divided frames including the area C1 suffer discrepancy.

Now, the increasing number of the divided areas when overlapping divided frames are used will be calculated. For example, when there are 6×4 divided frames that do not overlap one another, the number of forgery and fake check areas is 6×4=24. When there are 6×4 divided frames that overlap neighboring frames, the number of forgery and fake check areas is 6+5×4+3=77.

The watermarking device according to the present exemplary embodiment has a basic structure as shown in FIG. 1. However, in the present exemplary embodiment, since a collage attack can be defended against, the entire watermark generating unit is not required if the secret key is applied to the unit watermarks.

In the present exemplary embodiment, the frame dividing unit identifies divided frames that partially overlap neighboring divided frames, and the watermark generating unit generates the unit watermark for each identified divided frame. A file applying step is then performed to generate a final file. A description of steps that are the same as in the first exemplary embodiment will be omitted.

In the step of applying the generated watermark information with the file, the watermark is concealed in the original image file by appending the watermark as additional information, such as a header or footer, to the image file, or by modifying the original image file without affecting image quality according to the generated watermark information. In the latter case, unit watermark concealment is preferably performed on a non-overlapping area belonging to only one divided frame. That is, in FIG. 5, unit watermark information is concealed in the pixel data within the area A.

In the present exemplary embodiment, when the watermark generating unit generates the unit watermark for each divided frame, the file applying unit combines the unit watermarks in order of the divided frames to generate the additional information. The generated additional information is translated into a header or footer of the image file and appended to the image file, or translated into a header or footer of each image frame and appended to each image frame. Preferably, the additional information includes information on divided frame implementation (e.g., the size of the divided frame).

In the present exemplary embodiment, the information on the divided frames may include information on the size of the overlapping area, which may be fixed to a predetermined value. For example, the information on the divided frames may include coordinate values of horizontal and vertical axes indicating horizontal and vertical divisions, and the size value of the overlapping area.

The watermark checking device of the present exemplary embodiment has a basic structure as shown in FIG. 3. The watermark extracting unit of the present exemplary embodiment extracts watermark information from a received image file, collects dividing information of each image frame from the watermark information, and obtains a written unit watermark for each divided frame.

The divided frame identifying unit divisions an image frame constituting one screen based on the collected dividing information.

The unit-watermark calculating unit calculates the unit watermark for each divided frame by applying each pixel data of the divided frame to a predetermined watermark decoding algorithm. The comparing unit compares the calculated unit watermark to the unit watermark of each divided frame extracted by the watermark extracting unit. The similarity between the two watermarks indicates that the image of the divided frame is not forged or faked, and the difference between the two watermarks indicates that the divided frame is not reliable. In this case, when the watermarks for two or four neighboring divided frames are not accepted, the comparing unit determines that an overlapping area is forged or faked. For detailed processes and advantages, refer to FIG. 5. The comparing unit performs the above process on all the divided frames and outputs the result.

While the use of the overlapping divided frames, which is the second characteristic of the present invention, has been described in the present exemplary embodiment, a combination of the use of the overlapping divided frames and the use of the entire watermark with the secret key and the unit watermark with the public key, which is the characteristic of the first exemplary embodiment, is also possible. Also, a combination of the use of the overlapping divided frames and the use of the variable divided frames, which is the characteristic of the second exemplary embodiment, is possible too. Since the combination of the characteristic of the present exemplary embodiment and the characteristic of the first exemplary embodiment and/or the characteristic of the second exemplary embodiment can be easily inferred from the above description, an explicit description thereof will be omitted.

While the invention has been shown and described with reference to certain exemplary embodiments thereof, it will be understood by those skilled in the art that various changes in form and details may be made therein without departing from the spirit and scope of the invention as defined by the appended claims.

1. A watermarking method for embedding watermarks into a digital image file, the method comprising the steps of:
(a) generating an entire watermark for an image frame of the digital image file using a secret key;
(b) dividing the image frame into divided frames by at least one horizontal line and at least one vertical line;
(c) performing a predetermined watermark creating algorithm on pixel data of each divided frame and generating unit watermarks; and
(d) applying the entire watermark and the unit watermarks to the digital image file.

2. The method of claim 1, wherein step (c) applies a public key algorithm or a keyless algorithm.

3. The method of claim 1, wherein the divided frames in step (b) comprise at least one of divided frames obtained by dividing the image frame into fixed horizontal and vertical sizes, variable divided frames obtained by variably dividing an object area in the image frame into a size smaller than a background area, and divided frames partially overlapping neighboring divided frames.

4. The method of claim 3, wherein the variable divided frames are obtained by dividing the object area into a size smaller than the background area by using a variable divided frame pattern recognizing the object area and the background area in the image frame.

5. The method of claim 1, wherein the watermark generating algorithm in step (c) uses, as a function (F1) for creating the watermarks for the divided frames, an authentication function based on a cryptologic message authentication code.

6. The method of claim 3, wherein step (d) comprises the step of writing each unit watermark to the corresponding divided frame, the unit watermark being written to an area of the divided frame that does not overlap neighboring divided frames.

7. The method of claim 1, wherein step (d) comprises the steps of composing an additional information block including the unit watermarks, and embedding the additional information block to the digital image file.

8. A method for checking watermarks embedded in a digital image file, the method comprising the steps of:
(a) calculating an entire watermark for an image frame of the digital image file according to a predetermined algorithm using a secret key and determining whether the image frame is forged or faked;
(b) extracting a unit watermark for each divided frame from the image frame;
(c) dividing the image frame into a number of divided frames, and calculating a unit watermark for each divided frame according to a predetermined algorithm; and
(d) comparing the extracted unit watermark with the calculated unit watermark to determine whether each divided frame is forged or faked.

9. The method of claim 8, wherein step (c) comprises the step of applying a public key algorithm or a keyless algorithm.

10. The method of claim 8, wherein the divided frames comprise at least one of divided frames of fixed horizontal and vertical sizes, variable divided frames of different sizes, and divided frames partially overlapping neighboring divided frames.

11. The method of claim 10, wherein the variable divided frames are obtained by dividing an object area of the image frame into a size smaller than a background area.

12. The method of claim 10, wherein step (d) comprises the step of determining that an overlapping area is forged or faked when a watermark for a neighboring divided frame is not accepted.

13. A watermarking apparatus for embedding watermarks into a digital image file, the apparatus comprising:
an entire watermark generating unit for generating an entire watermark for an image frame of the digital image file;
a frame dividing unit for dividing an image frame to be watermarked into a number of divided frames;
a unit watermark generating unit for generating unit watermarks for each divided frame by applying a public key algorithm or a keyless algorithm; and
a file applying unit for applying the entire watermark and unit watermarks to the digital image file.

14. The apparatus of claim 13, further comprising:
a watermark key generating unit for generating a watermark key for the unit watermark generating unit; and
a key encrypting unit for encrypting the watermark key.

15. The apparatus of claim 13, wherein the frame dividing unit forms at least one of divided frames of fixed horizontal and vertical sizes, variable divided frames of different sizes, and divided frames partially overlapping neighboring divided frames.

16. The apparatus of claim 13, wherein the frame dividing unit determines an object area and a background area in the image frame and divides the object area into divided frames having a size smaller than the background area.

17. The apparatus of claim 13, wherein the file applying unit writes each unit watermark to the corresponding overlapping divided frame, the unit watermark being written to an area of the divided frame that does not overlap neighboring divided frames.

18. An apparatus for checking watermarks embedded in a digital image file, the apparatus comprising:
an additional-information extracting unit for extracting information on a watermarking scheme from a watermarked image file;
an entire-watermark checking unit for extracting and checking an entire watermark for the image frame from the image file using a secret key;
a frame dividing unit for dividing the image frame of the watermarked image file into a number of divided frames according to the additional information;
a unit-watermark extracting unit for extracting the unit watermark for each unit frame from the additional information;
a unit-watermark calculating unit for calculating the unit watermark by applying a predetermined watermarking algorithm to each divided frame; and
a comparing unit for comparing the extracted unit watermark for each divided frame to the calculated unit watermark to determine whether the image file is forged or faked.

19. The apparatus of claim 18, wherein the frame dividing unit forms at least one of divided frames of fixed horizontal and vertical sizes, variable divided frames of different sizes, and divided frames partially overlapping neighboring divided frames.

20. The apparatus of claim 18, wherein the frame dividing unit determines an object area and a background area of the image frame and divides the object area into divided frames having a size smaller than the background area.
